(19) United States
(12) Patent Application Publication
(10) Pub. No.: US 2021/0392922 A1
(43) Pub. Date: Dec. 23, 2021

(54) AQUEOUS COMPOSITIONS COMPRISING OMEGA NITROOXY-1-ALKANOLS

(71) Applicant: DSM IP ASSETS B.V., Heerlen (NL)

(72) Inventors: Nadia BAATI, Kaiseraugst (CH); Peter RIEBEL, Kaiseraugst (CH); Angela WILDERMANN, Kaiseraugst (CH)

(21) Appl. No.: 17/287,721

(22) PCT Filed: Oct. 24, 2019
(86) PCT No.: PCT/EP2019/079093

§ 371 Date: Apr. 22, 2021

(30) Foreign Application Priority Data
Oct. 25, 2018 (EP) 18202514.8

(51) Int. Cl. A23K 20/105; A23K 50/10

(52) U.S. Cl. CPC A23K 20/105; A23K 50/10

(57) ABSTRACT

The invention relates to safe aqueous compositions of ω-nitrooxy-C3-10alkane-1-ols.

The invention relates to safe aqueous compositions of ω-nitrooxy-C₃₋₁₀alkane-1-ols as well the use thereof.

Global temperature is increasing, a process referred to as global warming or climate change. One of the main focuses to reduce this warming effect is to reduce the amount of greenhouse gases emitted into the atmosphere. Greenhouse gases are emitted from several different sources, both natural and anthropogenic; however, the two sources with the biggest impact are the agricultural and fossil fuel industries. Within agriculture, ruminants and in particular cattle are the major contributors to the biogenic methane formation, and it has been estimated that the prevention of methane formation from ruminants would almost stabilize atmospheric methane concentrations.

3-Nitrooxypropanol (3-NOP, also known as 3-nitrooxy-propan-1-ol or 1,3-propanediol mononitrate) has been reported to be highly efficient in reducing the formation of methane in ruminants without affecting microbial fermentation in a way that would be detrimental to the host animal (WO-2012-084629-A1).

Even though 3-nitrooxypropanol incorporated into a solid animal feed form such as e.g. a mineral premix or feed pellets and/or in the form of a 10% adsorbate on silica is safe to use pure or liquid grades thereof such as in particular aqueous solutions thereof, are highly susceptible to decomposition upon elevates temperatures, the risk risings with increasing 3-nitrooxypropanol concentration levels. Thus, such grades require careful handling, storage and/or cold chain transportation. Consequently, there is an ongoing need for an aqueous product form, which allows safe handling, storage and transportation, in particularly at elevated 3-nitrooxypropanol concentrations, also on industrial and commercial level. A safe aqueous product form comprising elevated 3-nitrooxypropanol levels would furthermore be highly desirable, as this would also allow the supplementation of ruminants with 3-nitrooxypropanol directly via the drinking water.

Surprisingly it has now been found, that the addition of a salt of a mono-, di- or tricarboxylic acid or phosphoric acid to an aqueous composition of 3-nitrooxypropanol significantly reduced the decomposition energy (ΔH decomposition, in J/g). Furthermore, not only less heat during decomposition is produced, it is also produced at a slower rate i.e. less “violent”, (illustrated by the reduced heat production rate (q, in W/kg)), which effect is particularly pronounced when salts of monocarboxylic acids such as acetates are used.

Thus, in a first embodiment, the present invention relates to aqueous compositions (I), which are compositions comprising water, a ω-nitrooxyC₃₋₁₀ alkane-1-ol and at least one salt of a mono-, di- or tricarboxylic acid or phosphoric acid.

The term ‘ω-nitrooxyC₃₋₁₀alkane-1-ol’ refers to the linear ω-nitrooxyalkane-1-ols having 3 to 10 carbon atoms 3-nitrooxypropane-1-ol (also referred to as 3-nitrooxypropanol), 4-nitrooxybutane-1-ol, 5-nitrooxypentane-1-ol, 6-nitrooxyhexane-1-ol, 7-nitrooxyheptane-1-ol, 8-nitrooxyoctane-1-ol, 9-nitrooxynonane-1-ol and 10-nitrooxydecane-1-ol. Particularly preferred in all embodiments according to the present invention is 3-nitrooxypropanol.

Thus, in a second embodiment the present invention relates to aqueous compositions (II) which are aqueous compositions (I), wherein the ω-nitrooxyC₃₋₁₀ alkane-1-ol is 3-nitrooxypropanol.

Preferably, in all embodiments according to the present invention the at least one mono-, di- or tricarboxylic acid is a saturated linear or branched mono-, di-, or tricarboxylic acid having from 1 to 10, preferably from 1 to 6, more preferably from 2 to 5 carbon atoms, which acid optionally may be hydroxylated, preferably with 1 to 5 hydroxyl groups.

Particularly suitable monocarboxylic acids in all embodiments according to the present invention are formic acid, acetic acid, propanoic acid, isopropanoic acid, butanoic acid, pentanoic acid, hexanoic acid and gluconic acid as well as mixtures thereof. Particular preferred monocarboxylic acids in all embodiments of the present invention are linear unbranched C₁₋₆alkylcarboxylic acids, acetic acid and/or butyric acid being the most preferred.

Particularly suitable dicarboxylic acids in all embodiments according to the present invention are tartartic acid, malic acid, succinic acid, glutaric acid, and adipic acid.

A particularly suitable tricarboxylic acid in all embodiments according to the present invention is citric acid.

Preferably, the salts according to the present invention are alkali or alkaline earth metal salts and includes the respective mono, di- or tri-alkali or alkaline earth metal salts as well as mixtures thereof. More preferably, the alkali or alkaline earth metal salts in all embodiments of the present invention are sodium, potassium, magnesium and/or calcium salts of the respective acid such as in particular sodium acetate, potassium acetate, monosodium citrate, disodium citrate, trisodium citrate, calcium citrate, monosodium dihydrogenphosphate, disodium hydrogenphosphate, trisodium phosphate, calcium hydrogenphosphate and tricalcium phosphate.

Particular preferred salts of a mono-, di- and/or tricarboxylic acid or phosphoric acid in all embodiments of the present invention are the alkali salts of acetic acid and/or butyric acid, sodium acetate, potassium acetate and sodium butyrate being the most preferred.

In a particular advantageous embodiment, the present invention relates to aqueous compositions (III), which are aqueous compositions (I) or (II), wherein the at least one salt of the mono-, di- and/or tricarboxylic acid or phosphoric acid is an alkali or alkaline earth salt of acetic acid (i.e. an acetate alkali or alkaline earth salt), more preferably an alkali salt of acetic acid, most preferably sodium acetate or potassium acetate.

The amount of the ω-nitrooxyC₃₋₁₀alkane-1-ol in the aqueous composition according to the present invention is advantageously selected such that the ω-nitrooxyC₃₋₁₀alkane-1-ol is completely solubilized at ambient temperature (i.e. at 20° C.). It is further preferred that the amount of the ω-nitrooxyC₃₋₁₀alkane-1-ol in the aqueous compositions according to the present invention is at least 1 wt.-%, preferably at least 5 wt.-%, most preferably at least 7.5 wt.-%, such as at least 10 wt.-% or even at least 15 wt.-%, based on the total weight of the aqueous composition. Particular advantageous ranges include 1 to 25 wt.-%, 5 to 25 wt.-%, 10 to 25 wt.-%, 15 to 25 wt.-%, 1 to 20 wt.-%, 5 to 20 wt.-%, and 10 to 20 wt.-% of the ω-nitrooxyC₃₋₁₀alkane-1-ol, based on the total weight of the aqueous composition.

Thus, in a further embodiment, the present invention relates to aqueous compositions (IV), which are aqueous compositions (I), (II) or (III), wherein the amount of the ω-nitrooxyC₃₋₁₀ alkane-1-ol in the aqueous composition is at least 1 wt.-%, preferably at least 5 wt.-%, most preferably at least 7.5 wt.-%, such as at least 10 wt.-% or even at least 15 wt.-%, based on the total weight of the aqueous composition. Even more preferably, the amount of the ω-nitrooxyC₃₋₁₀alkane-1-ol in the aqueous composition is selected in the range of 1 to 25 wt.-%, 5 to 25 wt.-%, 10 to 25 wt.-%, 15 to 25 wt.-%, 1 to 20 wt.-%, 5 to 20 wt.-%, 10 to 25 wt.-% or 10 to 20 wt.-%, based on the total weight of the aqueous composition.

The total amount of the at least one salt of a mono-, di- or tricarboxylic acid or phosphoric acid in the aqueous composition according to the present invention is preferably selected such that at least 0.5 mole-equivalents, more preferably at least 0.75 mole-equivalents, most preferably at least 0.8 mole-equivalents, such as about 1 mole-equivalent of carboxylate and/or phosphate groups based on the amount of the ω-nitrooxyC₃₋₁₀alkane-1-ol are present (i.e. are added to the aqueous composition). The respective amounts can easily be adjusted by the person in the art and are exemplified in the examples. In case of monocarboxylic acids such as e.g. sodium or potassium acetate, respectively sodium butyrate, accordingly at least 0.5 mole-equivalents, more preferably at least 0.75 mole-equivalents, most preferably at least 0.8 mole-equivalents such as in particular about 1 mole-equivalent based on the amount of the ω-nitrooxyC₃₋₁₀ alkane-1-ol are used (i.e. for example: for 1 mole of a 3-nitrooxypropanol at least 0.5 mole-equivalent of sodium acetate are to be used), whereas in case of the sole use of tricarboxylic acids such as in particular trisodium citrate acid or trisodium phosphate only 0.17 mole-equivalents, more preferably 0.25 mole-equivalents, most preferably 0.3 mole-equivalents such as in particular about 0.33 mole-equivalents have to be used (i.e. for example: for 1 mole of a 3-nitrooxypropanol at least 0.17 mole-equivalent of trisodium citrate acid are to be used). Particular advantageous ranges include ranges from 0.5 to 2 mole-equivalents, preferably from 0.75 to 1.5 mole-equivalents, most preferably from 0.8 to 1.25 mole-equivalents such from 0.9 to 1.25 mole-equivalents of carboxylate and/or phosphate groups based on the amount of ω-nitrooxyC₃₋₁₀ alkane-1-ol.

Preferably, in all embodiments according to the present invention the molar ratio of the ω-nitrooxyC₃₋₁₀ alkane-1-ol to the carboxylate and/or phosphate groups of the at least one acid is selected in the range of 10:1 to 1:10, more preferably in the range of 5:1 to 1:5, most preferably in the range of 2.5:1 to 1:2, such as in the range of 0.8:1 to 1:1 (i.e. 10 moles of ω-nitrooxyC₃₋₁₀ alkane-1-ol and 1 mole of carboxylate and/or phosphate groups to 1 mole of the ω-nitrooxyC₃₋₁₀ alkane-1-ol and 10 mole of the carboxylate and/or phosphate, for example)

In a further advantageous embodiment, the present invention relates to aqueous compositions (V), which are aqueous compositions (I), (II) (III) or (IV), wherein the total amount of the at least one salt of the mono-, di- and/or tricarboxylic and/or phosphoric acid is selected such that at least 0.5 mole-equivalents, preferably at least 0.75 mole-equivalent, most preferably at least 0.8 mole-equivalents such as about 1 mole-equivalent of carboxylate and/or phosphate groups based on the amount of ω-nitrooxyC₃₋₁₀ alkane-1-ol are present in the aqueous composition.

In all embodiments of the present invention the amount of water in the aqueous composition is preferably at least 50 wt.-%, more preferably at least 60 wt.-%, most preferably at least 75 wt.-%, such as at least 80 wt.-%, based on the total weight of the aqueous composition.

Therefore, in a further embodiment, the present invention relates to an aqueous composition (VI), which are aqueous compositions (I), (II), (III), (IV) or (V), wherein the amount of water is at least 50 wt.-%, more preferably at least 60 wt.-%, most preferably at least 75 wt.-%, such as at least 80 wt.-%, based on the total weight of the aqueous composition.

The aqueous compositions may comprise further additives such as in particular an additional base such as preferably an alkali or alkaline earth hydroxide (e.g. NaOH, KOH, CaOH₂). Preferably, if present, the amount of the base is selected in the range of 0.005 to 0.1 mole-equivalents, preferably in the range of 0.01 to 0.05 mole-equivalents, most preferably in the range of 0.01 to 0.025 mole-equivalents based on the ω-nitrooxyC₃₋₁₀alkane-1-ol.

The pH of the aqueous composition according to the present invention is advantageously selected in the range of 5 to 13.5, more advantageously in the range of 5.5 to 13, most advantageously in the range of 6 to 12.5 and can be adjusted by a person skilled in the art, e.g. by addition of the above-mentioned bases or an acid such as acetic acid, citric acid and/or phosphoric acid further suitable pH ranges include the ranges from 6 to 13.5, 6.5 to 13, and 7 to 12.5.

It is furthermore preferred, that the compositions according to the present invention do not contain any sugar, i.e. are free of any sugar, do not contain any silica (silicon dioxide) and/or do not contain any molasses, i.e. are free of molasses.

Even more preferably, the aqueous compositions according to the present invention are aqueous compositions (VII), which are aqueous compositions (I), (II), (III), (IV), (V) or (VI) consisting essentially of water, the ω-nitrooxyC₃₋₁₀ alkane-1-ol, at least one salt selected from the group of salts of mono-, di- and tricarboxylic acids and phosphoric acid and optionally a base.

The term ‘consisting essentially of’ as used according to the present invention means that the total amount of the ingredients ideally adds up to 100 wt.-%. It is however not excluded that small amounts of impurities or additives may be present, with the proviso that the total amount of such impurities or additives is preferably less than 3 wt.-%, more preferably less than 2 wt.-%, most preferably less than 1 wt.-% and which are e.g. introduced via the respective raw materials.

In a particular advantageous embodiment, the aqueous composition according to the present invention is an aqueous composition (VIII) consisting essentially of
(i) 5 to 25 wt.-%, preferably 7.5 to 20 wt.-%, most preferably 10 to 15 wt.-% of 3-nitrooxypropanol,
(ii) at least 70 wt.-%, preferably at least 75 most preferably at least 80 wt.-% of water,
(iii) 0 to 0.25 wt.-%, preferably 0 to 0.1 wt.-%, most preferably 0 to 0.075 wt.-% of sodium or potassium hydroxide, and
(iv) 0.5 to 2 mole-equivalents, preferably 0.75 to 1.5 mole-equivalents, most preferably 0.8 to 1.25 mole-equivalents, based on the amount of the 3-nitrooxypropanol, of sodium acetate, potassium acetate and/or sodium butyrate,
   with the proviso that the total amount of the ingredients (i) to (iv) sum up to 100 wt.-%.

In a particular advantageous embodiment, the aqueous compositions according to the present invention are clear aqueous solutions, i.e. solutions wherein all ingredients are fully solubilized, and which do not exhibit any undesirable opalescence, turbidity, or precipitation and/or do not contain any solids or other non-solubilized materials.

It is furthermore preferred, that the aqueous compositions according to the present invention are low viscous liquids comparable to water. More preferably, the aqueous compositions according to the present invention exhibit a viscosity of less than 500 mPa·s, more preferably of less than 250 mPa·s, most preferably of less than 100 mPa·s (@ 20° C.). Even more preferably, the viscosity is selected in the range from 0.1 to 100 mPa·s, more preferably from 0.25 to 50 mPa·s, most preferably from 0.5 to 25 mPa·s (@ 20° C.).

Due to the enhanced safety aspects, the aqueous compositions according to the present invention are particularly suitable for transporting the ω-nitrooxyC₃₋₁₀alkane-1-ol, such as preferably the 3-nitrooxypropanol.

Thus, in a further embodiment, the present invention also relates to a transportation, shipping and/or storage container comprising an aqueous composition according to the present invention with all the definitions and preferences as given herein.

Suitable containers are well known to a person skilled in the art and encompass may be made from any material compatible with aqueous solutions such as plastic or stainless steel.

Furthermore, the present invention relates to a (safe) method of transporting 3-nitrooxypropanol, said method encompassing
(i) preparing an aqueous composition according to the present invention,
(ii) providing the aqueous composition into to a transportation, shipping and/or storage container and
(iii) transporting the container from one location to another, preferably at ambient temperature (i.e. without cooling or heating).

Exemplary means for transportation encompass ships, planes, cars/lorries and trains without being limited thereto.

The duration of transportation is preferably at least 1 h, but can also last for 1 to several days or even weeks.

The aqueous compositions according to the present invention can either be supplemented as such to ruminants e.g. as drinking water or as liquid feed supplement which optionally may comprise additional, preferably water soluble, feed additive(s), or be used in the preparation of an animal feed e.g. by incorporation thereof into feed pellets, mineral or vitamin premixes or be used for the preparation of powderous product forms e.g. by spraying onto a suitable carrier.

Thus, in a further embodiment, the present invention relates to the use of an aqueous composition according to the present invention such as in particular to an aqueous composition (I), (II), (III), (IV), (V), (VI), (VII) or (VIII) as drinking water for ruminants.

In another embodiment, the present invention relates to the use of an aqueous composition (I), (II), (III), (IV), (V), (VI), (VII) or (VIII) as a liquid feed supplement for animals such as in particular ruminants.

If the aqueous compositions according to the present invention are used as liquid feed supplement or as drinking water they can optionally be admixed with further additives commonly used in such supplements or drinking waters such as macro and micro minerals, vitamins, soluble carbohydrate sources (e.g. molasses sugar or solutions such as dextrose and the like), buffers, salts, thickeners (e.g. xanthan gum) and/or amino acids without being limited thereto.

Particularly suitable vitamins according to the present invention encompass water soluble vitamins such vitamin B12, biotin and choline, vitamin B1, vitamin B2, vitamin B6, niacin, folic acid and panthothenate, e.g. Ca-D-panthothenate. Particularly suitable micro minerals encompass iodine (e.g. in the form of sodium iodine), selenium, and cobalt. Particularly suitable macro minerals encompass calcium (e.g. in the form of limestone and calcium (mono, di or triphosphate), magnesium, phosphorus and sodium (e.g. in the form of sodium chloride).

In a particular advantageous embodiment, the liquid feed supplement further comprises at least one ingredient selected from the group of water-soluble vitamins, micro minerals, macro mineral and amino acids as well as mixtures thereof.

In a further embodiment, the present invention relates to the use of at least one salt of a mono-, di- or tricarboxylic acid or phosphoric acid with all the preferences and definitions as given herein to decrease the decomposition energy (ΔH_{dec}) and/or the heat (energy) production rate (q) of a ω-nitrooxyC₃₋₁₀ alkane-1-ol, preferably of 3-nitrooxypropanol in water.

In another embodiment, the present invention relates to a method to reduce the decomposition energy (ΔH_{dec}) and/or the heat (energy) production rate (q) of a solution of a ω-nitrooxyC₃₋₁₀ alkane-1-ol, preferably of 3-nitrooxypropanol in water, said method comprising the step of adding at least one salt of a mono-, di- or tricarboxylic acid or phosphoric acid with all the definitions and preferences as given herein to said solution.

In further embodiments the present invention relates to the use of aqueous composition according to the present invention such as in particular to an aqueous composition (I), (II), (III), (IV), (V), (VI), (VII) or (VIII) as a supplement for ruminants to reduce the formation of methane in ruminants.

Furthermore, the invention relates to a method of administering ruminants an aqueous composition according to the present invention such as in particular an aqueous composition (I), (II), (III), (IV), (V), (VI), (VII) or (VIII) to reduce the methane emission of said ruminants.

### Example 1: Thermal Stability

Thermal decomposition characteristics of aqueous compositions comprising 10 wt.-% of 3-nitrooxypropanol alone, in combination with the respective wt.-% of a salt and optionally further with a base (water ad 100 wt.-%) as outlined in table 1 were analyzed by differential scanning calorimeter (DSC). DSC apparatus is a conventional instrument for thermal hazard evaluation of unstable material. Temperature programmed screening experiments were performed on a Mettler Toledo DSC 3. The test cells are gold-plated high-pressure resistant steel crucible that could withstand pressure of about 20 MPa. The samples are of approximately 5 mg material are injected into the test cells by a pipette, and then mechanically sealed. The DSC tests of dynamic scanning were performed at temperatures from 30° C. to 400° C. with heating rate of 4 K/min. The detection sensitivity is 0.04 μW. Thermal curves of DSC were acquired from the build-in STARe software.

Based on the DSC thermogram, several characteristics of the thermal behavior of the compositions of 3-nitrooxypropanol can be evaluated such as the energy released upon its thermal decomposition (ΔH_{dec}) and the heat (energy) production rate (q).

TABLE 1
acetate and butyrate salts

| | | Ref | Inv-1 | Inv-2 | Inv-3 | Inv-4 | Inv-5 | Inv-6 | Inv-7 |
|---|---|---|---|---|---|---|---|---|---|
| NaOAc | wt.-% | — | 3.3 | 3.4 | 5.4 | 6.7 | 6.7 | — | — |
| KOAc | wt.-% | — | — | — | — | — | — | 7.9 | — |
| NaOBu | wt.-% | — | — | — | — | — | — | — | 8.1 |
| NaOH | wt.-% | — | — | 0.06 | — | — | 0.05 | — | — |
| mole-eq.* | | — | 0.5 | 0.5 | 0.8 | 1 | 1 | 1 | 1 |
| ΔH_{Dec} | J/g | −365 | −245 | −250 | −180 | −155 | −170 | −165 | −90 |
| q | W/kg | 1400 | 960 | 910 | 420 | 130 | 120 | 140 | 110 |

*mole-eq.: mole-equivalent of the salt of the respective carboxylic/
phosphoric acid salt, based on the 3-nitrooxypropanol

TABLE 2
citrate and phosphate salts

| | | Ref | Inv-8 | Inv-9 | Inv-10 |
|---|---|---|---|---|---|
| Na₃Citrate | wt.-% | — | 8.0 | — | — |
| Na₃PO₄ | wt.-% | — | — | 4.5 | — |
| Na₂HPO₄ | wt.-% | — | — | — | 5.5 |
| mole-eq.* | | — | 0.4 | 0.3 | 0.5 |
| ΔH_{Dec} | J/g | −365 | −200 | −185 | −205 |
| q | W/kg | 1400 | 320 | 220 | 340 |

*mole-eq.: mole-equivalent of the salt of the respective carboxylic/phosphoric acid salt, based on 3-nitrooxypropanol

When subjected to high temperatures, 3-NOP decomposes violently as indicated by a high ΔH_{dec} (−365 J/g) and a high q-value. Under heat confinement, or adiabatic conditions the energy produced by the decomposition reaction is not evacuated from the reacting mass which can therefore overheat. Thus, the thermal decomposition in turn leads to an important temperature rise. The rise in temperature would then lead to an acceleration of the decomposition reaction rate.

When testing a composition according to the present invention the thermal behavior of the composition is significantly modified. The decomposition energy (ΔH_{dec}) as well as the heat (energy) production rate (q) is significantly reduced, which effect is particularly pronounced in the case of equimolar amounts of the respective salt and even more pronounced in case of the use of acetate salts (Inv-4 to Inv-6).

1. An aqueous composition comprising water, a ω-nitrooxyC₃₋₁₀alkane-1-ol and at least one salt of a mono-, di- or tricarboxylic or phosphoric acid, characterized in that
a. the amount of the ω-nitrooxyC₃₋₁₀alkane-1-ol is at least 5 wt.-% and the amount of water is at least 50 wt.-%, based on the total weight of the aqueous composition and
b. the total amount of the at least one salt of the mono-, di- and/or tricarboxylic acid or phosphoric acid is selected such that at least 0.5 mole-equivalents of carboxylate and/or phosphate groups based on the amount of the ω-nitrooxyC₃₋₁₀alkane-1-ol are present in the aqueous composition.

2. The aqueous composition according to claim 1, wherein the ω-nitrooxyC₃₋₁₀ alkane-1-ol is 3-nitrooxypropanol.

3. The aqueous composition according to claim 1, wherein the at least one salt is selected from the group of an alkali or alkaline earth metal salt of acetic acid, butyric acid, citric acid and phosphoric acid, preferably from the group of sodium acetate, potassium acetate, sodium butyrate, trisodium citrate, trisodium phosphate and disodium hydrogen phosphate, most preferably from the group of sodium acetate, potassium acetate and sodium butyrate.

4. The aqueous composition according to claim 1, wherein the amount of the ω-nitrooxyC₃₋₁₀alkane-1-ol is at least 7.5 wt.-%, preferably at least 10 wt.-%, based on the total weight of the aqueous composition.

5. The aqueous composition according to claim 1, wherein the amount of the ω-nitrooxyC₃₋₁₀alkane-1-ol is selected in the range from 5 to 20 wt.-%, more preferably from 10 to 20 wt.-%, based on the total weight of the aqueous composition

6. The aqueous composition according to claim 1, wherein the total amount of the at least one salt of the mono-, di- and/or tricarboxylic acid or phosphoric acid is selected such that at least 0.75 mole-equivalents, preferably at least 0.8 mole-equivalents, most preferably about 1 mole-equivalent of carboxylate and/or phosphate groups based on the amount of the ω-nitrooxyC₃₋₁₀alkane-1-ol are present in the aqueous composition.

7. The aqueous composition according to claim 1, wherein the amount of water is at least 60 wt.-%, preferably at least 75 wt.-%, most preferably at least 80 wt.-%, based on the total weight of the aqueous composition.

8. The aqueous composition according to claim 1, wherein the composition consists essentially of water, a ω-nitrooxyC₃₋₁₀alkane-1-ol, a salt of a mono-, di- and/or tricarboxylic acid or phosphoric acid and optionally a base.

9. Use of an aqueous composition according to claim 1 as drinking water for ruminants.

10. A liquid feed supplement comprising an aqueous composition according to claim 1, wherein the composition comprises at least one further feed additive.

11. The liquid feed supplement according to claim 10, wherein the feed additive is selected from the group of water-soluble vitamins, micro minerals, macro mineral and amino acids as well as mixtures thereof.

12. Use of an aqueous composition according to claim 1 in the preparation of an animal feed, a mineral or vitamin premix or a powderous product form.

13. A process for the preparation of a liquid feed supplement, wherein said method encompasses admixing an aqueous composition according to claim 1 with a feed additive, preferably a water-soluble feed additive.

14. A process according to claim 13, wherein the feed additive is selected from the group of water-soluble vitamins, micro minerals, macro mineral and amino acids as well as mixtures thereof.

15. Use of at least one salt of a mono-, di- and/or tricarboxylic acid or phosphoric acid to decrease the decomposition energy and/or the heat (energy) production rate of a ω-nitrooxyC₃₋₁₀ alkane-1-ol, preferably of 3-nitrooxypropanol in water.
